(19) United States
(12) Patent Application Publication
(10) Pub. No.: US 2018/0204078 A1
(43) Pub. Date: Jul. 19, 2018

(54) SYSTEM FOR MONITORING THE STATE OF VIGILANCE OF AN OPERATOR

(71) Applicant: INNOV PLUS, Orsay (FR)

(72) Inventors: Jimmy SENG, Orléans (FR); Patrice LACROIX, Limours (FR)

(73) Assignee: INNOV PLUS, Orsay (FR)

(21) Appl. No.: 15/742,820

(22) PCT Filed: Jul. 8, 2016
(86) PCT No.: PCT/FR2016/051756

§ 371 Date: Jan. 8, 2018

(30) Foreign Application Priority Data
Jul. 10, 2015 (FR) 1556584

(51) Int. Cl. G06K 9/00; B60W 50/16

(52) U.S. Cl. CPC G06K 9/00845; B60W 50/16; G06K 9/00255; G06K 9/00335

(57) ABSTRACT

The present invention relates to a system for monitoring the state of vigilance of an operator including: a camera furnished with a sensor responsive in the near infrared, a circuit for real-time processing of the signals delivered by the camera, so as to determine characteristic points for each of the images. By analysing the characteristic points, the information relates to a part at least of the indicators including: the inclination of the head in three orthogonal directions, the position of the pupil, the opening of the eye, and/or the configuration of the mouth. Furthermore, a computer controlled by a program determines the state of vigilance as a function of the indicators and of their temporal evolution.

### CROSS REFERENCE TO RELATED APPLICATIONS

This application is a National Phase Entry of International Patent Application No. PCT/FR2016/051756, filed on Jul. 8, 2016, which claims priority to French Patent Application Serial No. 1556584, filed on Jul. 10, 2015, both of which are incorporated by reference herein.

### TECHNICAL FIELD

The present invention relates to the field of the automatic analysis of the state of vigilance of an operator, in particular of a driver of an automobile, rail, sea or air vehicle, or of an operator controlling or monitoring an item of equipment or an industrial, maritime or air site. Among the various known solutions, the invention relates more particularly to those based on facial analysis for detecting changes representing a variation in the state of vigilance or the appearance of signs that are precursors of drowsiness.

### BACKGROUND

Various solutions for the automatic analysis of vigilance using facial recognition are known in the prior art. The European patent application EP 2060993 describes a vigilance-detection system comprising an imaging device positioned so as to obtain a plurality of images of a portion of the head of a subject and a vigilance processor receiving the images, carrying out a classification according to the posture of the head and monitoring of the movement of at least one eye. The state of vigilance is determined on the basis of the movement of the eye being monitored and two images for determining a motion vector.

The U.S. Patent Publication No. 2012/242819 describes a system for detecting the vigilance of a driver comprising an imaging unit configured so as to image a zone of a vehicle compartment, where the head of the driver is situated; an image processing unit configured so as to receive the image from the imaging unit, and for determining the positions of the head and eyes of the driver; and a warning unit configured so as to determine, on the basis of the determined position of the head and eyes of the driver output by the image processing unit, whether the driver is in an alert state or a non-alert state, and for delivering a warning to the driver when the driver is determined as being in the non-alert state.

The solutions proposed in the prior art present a major problem for use in on-board equipment having limited processing capacity. The real-time processing of images having a high resolution to allow the extraction of useful information according to the methods of the prior art requires significant computing power, not very compatible with processors such as those that can be found on a mobile telephone or on-board equipment. Moreover, the solutions of the prior art are not very robust with respect to the direction of the image capture: when the operator turns his head and is no longer facing the acquisition camera, the analysis processing operations lose their efficacy. The solutions of the prior art are very sensitive to the precise positioning of the camera with respect to the operator.

Another drawback of the solutions of the prior art is the difficulty in adapting and optimising the processing to the specificities of a given operator. Even if the loss-of-vigilance indices can be classified generically, a given operator may have significant differences and have particularities with regard to his signs that are precursors of falling asleep or a drop in vigilance. Lastly, the solutions of the prior art are limited to single-person processing, and do not make it possible to share general information on the risks of drowsiness or loss of vigilance as a function of time or geolocation.

Moreover, the information limited to the movement of the eye and to the orientation of the head is not sufficient to provide reliable information on the state of vigilance of the person being observed. In the solution described in the patent EP 2060993, the simple classification of the image as “frontal” or “non-frontal” and the information on the monitoring of the eye by a counter and incremented so as to classify the subject observed as “inattentive” provides only very approximate or even erroneous results.

### SUMMARY

In order to remedy these drawbacks, the present invention, in accordance with its most general acceptance, relates to a system for monitoring the state of vigilance of an operator, comprising:
a camera provided with a sensor sensitive in the near infrared, oriented so as to acquire an image of the face occupying at least 12% of the useful surface of the sensor,
a circuit for the real-time processing of the signals delivered by said camera, in order to determine characteristic points for each of said images and, by analysing said characteristic points, information relating to at least some of the indicators comprising:
   the inclination of the head in three orthogonal directions,
   the position of the pupil
   the opening of the eye
   the configuration of the mouth
a computer controlled by a program determining the state of vigilance according to said indicators and the change over time thereof
said system comprises:
   a first permanent memory for recording a plurality of files FDᵢ obtained by a prior processing on a set of images IAᵢ and an indicator qualifying the belonging of each of said images VAᵢ to a predetermined class (real face, face that is not a real one)
   a second permanent memory for recording a plurality of files FCᵢ obtained by a prior processing on a set of images of faces Vᵢ associated with annotations
said processing circuit performing a step of location, in the digital image delivered by the camera, of the zones corresponding to the face, by applying a detection processing using said files IAᵢ
said processing for determining characteristic points by applying a detection processing using said files Vᵢ
the information relating to the state of the head of said operator comprises indicators on inclination of the head in three orthogonal directions.

According to a variant, said computer is also controlled by a program for detecting the direction of the gaze and calculating an additional indicator. Preferably, the frequency of acquisition and processing is greater than 30 images per second. According to an advantageous embodiment, a time-stamped recording is carried out of said indicators and the change over time is calculated according to said recordings, over a time range of at least two seconds. According to a variant, it comprises an alert means controlled remotely by said computer, activating a haptic means.

According to a particular embodiment, the system comprises an alert means controlled by said computer, activating an audible means. According to another particular embodiment, the system comprises an alert means controlled by said computer, activating a light means. According to another particular embodiment, the system further comprises environment sensors not connected to said operator, delivering an additional signal for computing the state of vigilance.

Advantageously, the system further comprises at least one physiological sensor connected to said operator, delivering an additional signal for computing the state of vigilance. According to a variant, it further comprises means for transmitting said indicators to a server, and means for computing generic information (not connected to a given operator) on risk zones. Advantageously, it further comprises a third memory for recording data coming from a plurality of items of external equipment and from a server, for recording additional information for computing the state of vigilance.

According to a particular embodiment, the server is configured so as also to receive external data and to transmit additional information to each local item of equipment. Preferably, it further comprises means for transmitting to a server at least some of the images acquired by the camera, in order to supplement the files FCᵢ. According to a preferred embodiment, the system further comprises a source emitting in the near infrared in order to illuminate the face of the operator. According to another advantageous variant, the system further comprises an electronic toll-payment circuit.

### BRIEF DESCRIPTION OF THE DRAWINGS

The invention will be understood better from a reading of the following description relating to a non-limitative example embodiment with reference to the accompanying drawings, where:

FIG. 1 shows a schematic view of the hardware architecture of the equipment;

FIG. 2 shows a schematic view of the installation of the equipment in a cockpit;

FIG. 3 shows a schematic view of the functional architecture of the equipment;

FIG. 4 shows a schematic view of the nature of the morphological characteristics detected on a face; and

FIG. 5 shows a schematic view of the various movements analysed.

### DETAILED DESCRIPTION

### Hardware Architecture

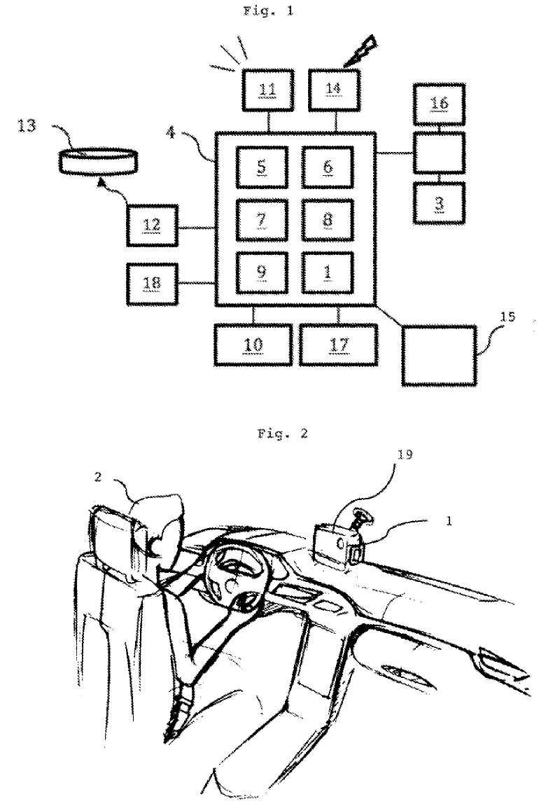

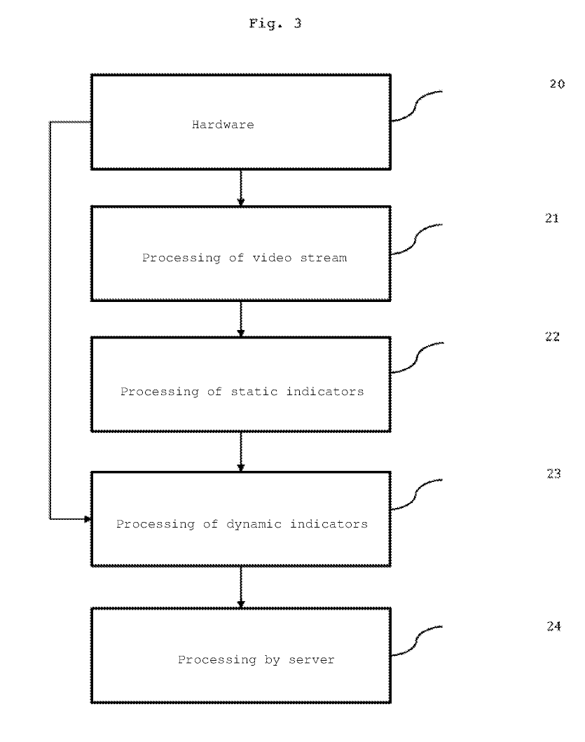

FIG. 1 shows a schematic view of the hardware architecture of on-board equipment that can be used in the cabin of a car or a bus or lorry, and FIG. 2 an example of installation in a cabin of a vehicle. The equipment (19) comprises an acquisition camera (1) positioned in the vehicle cabin, facing the driver (2), with a slight offset in order not to mask the field of vision. It may in particular be held by an arm fixed to the dashboard or to the windscreen.

This camera (1) is mounted in a housing also comprising a light source (3) emitting a wave in the near infrared emitting at 850 nm. The emission power is typically 100 mW per steradian (and preferably between 50 and 200 mW/sr). The IR emission is continuous, or may be modulated according to the ambient illumination, and the frequency of acquisition.

The acquisition sensor of the camera (1) has a resolution of 640×480 at least (type VGA), at an acquisition frequency of 100 images per second. It is associated with a high-pass filter with a cut-off wavelength of between 800 and 830 nm. The lens of the camera is determined, for an application installed in a car cabin, so as to provide a field of vision of 80×80 cm at a distance of one metre. The camera (1) may be associated with a brightness sensor (16) and with a motorised support so as to control an automatic following of the movements of the face.

The camera (1) is connected to a computer (4) comprising a microprocessor (5). This microprocessor (5) includes a multicore computing unit (6) and a graphics processor (7), ROM (8) and RAM or flash (9) memories for storing intermediate data, as well as a connector (19) for receiving a flash memory in which the application program code is recorded. It also includes, in a known fashion, the input/output interfaces, the management of the power supply and the protocol and security layers.

The equipment also comprises control buttons (17) and a display screen (10) forming the man-machine interface enabling the operator to carry out parameterising, and also intended to display graphical alerts generated by the computer (4) as well as graphical representations representing the state and level of vigilance. An external light source, for example a light strip or a flash (14), remotely controlled by the equipment, for supplementing the visual information.

Optionally, the housing controls the display of a type of alert associated with the descriptors that led to the triggering of this alert, for example a graphical signal symbolising a risk of falling asleep, associated with text or voice information on a number of closures or blinking of the eyes or yawning. The housing may, at the time of initialisation, trigger an informative sequence, optionally personalised according to historical data associated with the operator, the time and/or the location, or external data (temperature, meteorological conditions, etc.).

The equipment (1) also comprises a loudspeaker (11) or an interface controlling the vehicle sound equipment as well as an interface (12) of the Bluetooth type (trade name) intended to transmit control signals to a bracelet or to a connected vibrating object (13) intended to transmit haptic alerts to the operator, in the form of vibrations. The equipment also comprises inputs for additional sensors (15), for example a noise ambience sensor, an ambient temperature sensor, an accelerometer, a gyroscope, geolocation and vehicle-speed signals supplied by a GPS, etc. The equipment also comprises radio communication means (18) for transmitting data to a server, and receiving external data, in accordance with a known protocol. The power supply is achieved by connection to an accessory socket of the vehicle.

### Functional Description

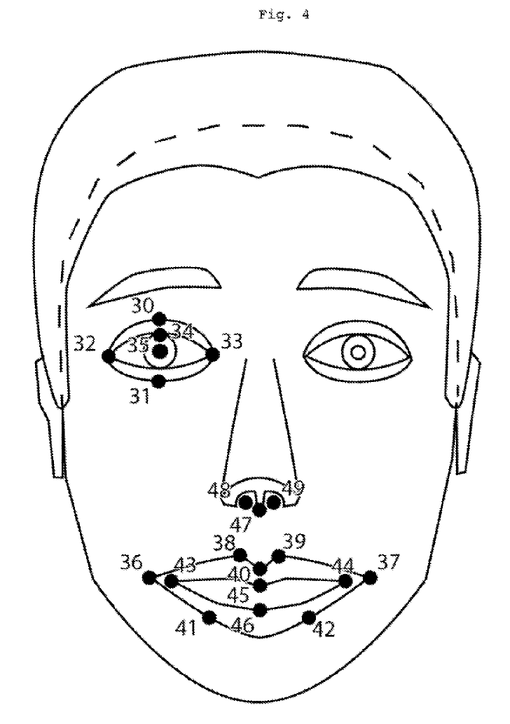

FIG. 3 shows a general view of the functional architecture. It comprises a first hardware block (20) relating to the management of the equipment (1) and its components. The second block (21) corresponds to the processing of the video stream coming from the camera for extracting static morphological characteristics CMᵢ. These processing operations are performed on images in 256 levels of grey (8 bits).

The third block (22) corresponds to the processing operations applied to the static morphological characteristics CMᵢ in order to compute dynamic indicators related to the face. The fourth block (23) corresponds to the processing operations applied to these dynamic indicators as well as to additional data coming from internal sensors and optionally from a server. The fifth block (24) corresponds to the processing operations performed by a server according to data coming from a plurality of items of equipment for supplying general data and improving the models recorded in each item of equipment.

The functioning of the equipment is as follows. The equipment (1) is placed facing the operator. Activating the equipment leads in a known manner to the automatic loading of the program recorded in the flash memory (19).

Executing the program triggers a first sequence of verification and dialogue with the operator. During this sequence, the equipment (1) transmits voice and text information, for example the safety recommendations and instructions for use of the system. It optionally makes it possible to request the operator to formally accept use, in order to comply with local regulatory provisions, in particular with regard to matters of responsibilities or protection of personal data.

This sequence also makes it possible to check the functioning of the vibrating, audible and visual interfaces, to select those that the operator wishes to activate, and to proceed with settings, for example of the level or mode of these alerts for the journey. After this initialisation sequence, the equipment carries out various processing operations in real time.

### Detection of Faces—Block (21)

This processing relates to the recognition, in the images acquired at a frequency of 100 images per second, of the face in the optical field, for two purposes that will be set out below:
search in a historical base for the data associated with a recognised face
the morphological-analysis processing operations for computing the state of vigilance.
   The face is detected in the image acquired by the camera in accordance with the Viola-Jones method described for example in the article by Paul Viola and Michael Jones, “Robust Real-Time Face Detection”, IJCV, 2004, p. 137-154.

This step makes it possible to isolate in the whole of the image the zone containing the face. This zone represents a subset of at least 12% of the whole of the image in the optical field, which makes it possible to reduce the computing power necessary for subsequent processing operations. The following step consists of applying processing operations for calculating static morphological characteristics of the face in the previously delimited zone.

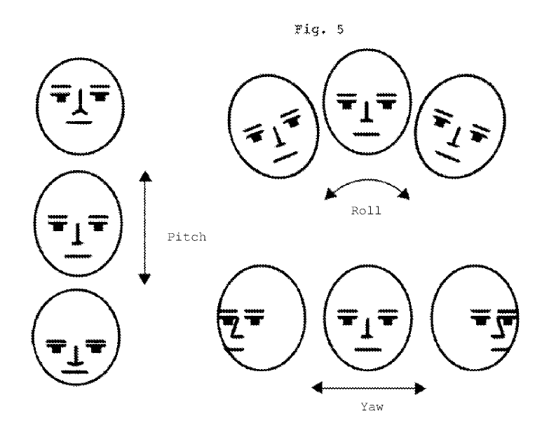

These morphological characteristics CMᵢ illustrated by FIG. 4 comprise for example:

the characteristic points of the eye and eyelid, for each of the eyes:
centre of the superior-exterior part of the right eyelid (30)
centre of the superior-interior part of the right eyelid (34)
outer corner of the right eye (32)
inner corner of the right eye (33)
centre of the inferior-interior part of the right eyelid (31)
centre of the pupil of the right eye (35)
and various other characteristic points of the eye

the characteristic points of the mouth:
the right-hand corner of the outside of the lip (36)
the left-hand corner of the outside of the lip (37)
the highest point of the right-hand exterior of the lip (38)
the highest point of the left-hand exterior of the lip (39)
the central point of the exterior of the top lip (40)
the point of change of direction of the right-hand part of the bottom lip (41)
the point of change of direction of the left-hand part of the bottom lip (42)
the right-hand corner of the inside of the lip (43)
the left-hand corner of the inside of the lip (44)
the central point on the top part of the interior lip (45)
the central part on the bottom part of the interior lip (46)
and where applicable other characteristic points of the lips, etc.

the characteristic points of the nose:
the base of the inter-nostril partition of the nose (47)
the centre of the right nostril (48)
the centre of the left nostril (49).

### Construction of a Deformable Model

The processing carried out in block (21) is carried out according to models previously generated and recorded in the ROM memory (8). An example of processing for constructing the deformable model will be presented later. A model is generated from a sequence of a plurality of images of faces, on which a manual characterisation is being carried out.

This characterisation consists of designating, on each of the images, manually or automatically, the aforementioned characteristic points CMᵢ. In this way a set of data (CMᵢ, x_{cmi}, y_{cmi}) consisting of coordinates (x_{cmi}, y_{cmi}) associated with their descriptor (CMᵢ) is constructed. From these data, a shape model constituting a reference template is constructed. For each of the characteristic points, the distribution of the points issuing from the various faces processed and the limit of the variations are defined on this template.

These characteristic points are recognised by means of an analysis of main components ACP, by a processing operation consisting of comparison between the characteristics CMRᵢ on a reference model, and the shifts between each of the points CMᵢ. The steps leading to the obtaining of a model mentioned previously correspond to a known method, for example in the article “Active Appearance Models Revisited” by lain Matthews and Simon Baker.

The processing is based on the use of a plurality of face models, the photographing of which is not constant but varies according to the orientation of the face with respect to the camera. After the model is generated, a reference position and the authorised shifts, vis-à-vis this position, are associated with each point on the set CMᵢ, so that the set represents a plausible human face.

Thumbnails Associated with the Deformable Model

This deformable model is supplemented by thumbnails corresponding to textures located around the characteristic points CMᵢ representing the vicinity of these points. This information makes it possible to validate the zones of interest in which the characteristic points are situated. In this way a deformable model is constructed associated with the characteristic points CMᵢ a thumbnail of a small number of pixels surrounding these characteristic points.

### Reference Base

A plurality of deformable models are generated according to the various variations over the plurality of usable images (great diversity in the positions and expressions of the faces). These models are recorded in a reference base which will be used for the real-time processing of the images coming from the equipment (1). The recorded models comprise:

a front reference model

a left-hand quarter profile reference model

a right-hand quarter profile reference model

a left-hand profile reference model

a right-hand profile reference model

With each model there is associated its own set of thumbnails.

### Initialisation of the Face Detection

During the first acquisitions, the processing will select, in the reference model base, one of the models that is most suited. This selection is made by computing a history of use. According to the identity recognised, the computer loads the parameters associated with the profile recognised. If no face is recognised, the computer loads standard parameters, constructed by local or extended learning (from data coming from a server).

### Processing on Each Image Transmitted by the Equipment

For an image Iₜ, the zone containing the graphical information corresponding to the face is selected, and a processing operation is applied in order to identify the characteristic points CM_{i,t} from the data of the reference model selected. These characteristic points CM_{i,t} are extracted recurrently, with a first rough characterisation step and then additional steps of fine characterisation and validation of the points identified.

The characteristic points CM_{i,t} are followed on the basis of their deformable model, their own thumbnail and the points at time t-1 CM_{i,t-1}. The deformable model makes it possible to place the points at average positions and to limit their deformations within the limit of a plausible face form. The thumbnails are used to determine the precise location of the characteristic point, which is associated with it, on the image at the time t. The exact position results from a calculation of correlation between said thumbnail and a zone of the image close to the characteristic point.

The additional steps consist of verifying the coherence of the relative position of pairs of characteristic points, validating the points where the coherence indicator reaches a threshold value and reprocessing the residual points. The result of this step is a set of time-stamped points CM_{i,t} for the image processed, associated:
with an indicator of the degree of confidence, representing the reality of the qualification and of the position of the associated characteristic point
optionally with geolocation data coming from a GPS.
   This processing is carried out in parallel, for all the characteristic points, for example 56 points, by one execution on the GPU coupled processor (7).

### Computation of Static Indicators

These data are the subject of a processing operation for computing an indicator representing:
the position of the head
the head posture Pₜ (the static orientation on 3 axes, pitch, roll, yaw) as illustrated by FIG. 5 according to the points CM_{i,t} having the highest confidence score, as well as the history of the posture of the head in order to check the coherence of the posture Pₜ. The posture Pₜ of the head is calculated according to a three-dimensional model of a face, the vertices of which are associated with the 2D points of the reference model.

The three-dimensional model is generated upstream and is non-deformable. This model is formed by a rigid mesh, consisting of a plurality of groups of points (for example the points of the mesh of the jaw, or of the eyes defining the width and separation of the eyes). The positions of the points in a group are computed at the time of initialisation in order to adapt a predefined generic mesh to the morphology determined during the first operator image acquisitions, in order to adapt this standard mesh to the morphology of a particular operator.

This solution significantly reduces the computing power required compared with solutions where the three-dimensional model is recalculated for each new image acquisition of the face. This personalised model can be updated periodically, at a periodicity very much greater than that of the acquisition, for example every minute or ten minutes, whereas the periodicity of acquisition of the image acquisition is around a hundredth of a second. The recomputation of the three-dimensional model may be activated when there is a repeated detection of disagreements between the 2D points and the points of the 3D mesh projected onto the 2D image.

This recomputation makes it possible to adapt the three-dimensional model to the morphology of the driver during a long journey. The back projection of the 2D points to 3D by means of intrinsic parameters (for example radial distortions) and extrinsic parameters (for example rotation, translation and scaling matrices) of the acquisition system makes it possible to control the properties of the lens.

Another static processing concerns the determination of an indicator representing the state of each eye (for example the percentage opening of the eye), as well as an indicator representing the position of the pupil. This processing consists of carrying out an image pre-processing in the zone of interest around the eye; modelling the eye and predicting its movements and its position with respect to the characteristic points (right-hand corner, left-hand corner, top, bottom, etc.). Another static processing relates to the determination of an indicator representing the direction of the gaze. This processing is based on the computation of the coupling between the position of the head and the direction of the gaze.

Another static processing relates to the determination of an indicator representing the state of the mouth. This processing consists of isolating part of the image in the zone of interest around the mouth and then attributing a mouth state classification: neutral-discussion-yawning. These various static indicators are recorded in a time-stamped form and where applicable geolocated in a local database, and are transmitted periodically to the server.

### Computation of Dynamic Indicators of the Change Over Time in the Static Indicators

These static indicators are the subject of processing operations for computing dynamic temporal-change indicators, for example:

number of blinks of the eyelid

duration of closure of the eyelids

duration of closure and/or opening of the mouth

distribution of the durations of the gaze per category of zone

### Computation of One or More Qualitative or Quantitative Indicators of the State-of-Vigilance Block (23)

The static indicators, in particular the posture of the head, as well as the dynamic indicators, are used periodically to compute quantitative and/or qualitative indicators representing the state of vigilance or somnolence (microsleep, distraction, etc.), and to demand the triggering of alert and display in the event of threshold values being exceeded. These indicators are also transmitted, in a time-stamped and geolocated form, to the server, to allow global processing of the information transmitted by a plurality of items of equipment, during extended time ranges, and to provide data such as the periods or zones generating atypical levels of loss of vigilance and somnolence.

The equipment also demands the display of changes in the state of vigilance on a display screen. This displayed information may be supplemented by external data coming from the server, for a prediction of loss-of-vigilance zones according to the data from the server. The external data are also used to parameterise the alerts and the algorithms for calculating the indicators, for example in order to adapt the sensitivity level or the processing frequency.

### Processing Operations by the Server

The data coming from a plurality of on-board systems may be collected periodically by a server, asynchronously for example, or form a set of data comprising, for an acquisition instant sampling:
the characteristic points computed at the output of block (21) from data acquired by the camera,
the data transmitted by the additional sensors (GPS, accelerometer, brightness, temperature, etc.),
the time stamping of these data and the association of an identifier of the operator,
optionally the raw data acquired by the camera, and from which the characteristic points were computed.

These sets of data are used on the server for three purposes:
optimisation of the three-dimensional models and models for computing the computing variables
formation of a reference base for the signs that are precursors of somnolence or hypovigilance
formation of a reference base for the temporal and geographical zones where losses of vigilance occur in a repeated fashion.

This information is retransmitted periodically to the various items of on-board equipment:
to update the models and computing variables
to enhance the data processed in geographical zones and at particular time periods, to trigger alerts and/or to parameterise the processing operations, in particular the sensitivity of the processing operations.
   This information may also be transmitted to fixed equipment, for example indicator panels, the state of which varies according to the data transmitted by the server, and where applicable the proximity of on-board equipment and the signals transmitted.

### Model Learning

The deformable model is formed at an initial stage from a collection of fixed face images, taken with persons with different morphologies, under different photography conditions, and different orientations. From these images, an automatic or manual pointing is carried out, for each of these images, to each of the characteristic points recognised, the position of the head and the expression, in order to construct a learning base. This set of data is then the subject of statistical processing of the type consisting of analysis into main components in order to construct an average template associated with variation modes with a given standard deviation in order to provide a digital model for automatic determination of the characteristic points and orientations of the head from an unknown image.

### Multifunction Box

According to a particular implementation, the system according to the invention is integrated in a single box further comprising a motorway toll payment circuit. This box is fixed to the windscreen in a central zone, or the shell of the cabin, in the detection cone of the toll payment equipment. This position is particularly suited for the acquisition of the face, since the space separating the thus-positioned box from the driver has no elements liable to mask the optical field. Such a dual-function box makes it possible to improve the safety of the operator but also other users, by offering the possibility of encouraging a driver whose system has registered an abnormally high level of loss-of-vigilance signals to rest or not to travel over a new traffic section.

1. A system for monitoring a state of vigilance of an operator, comprising:
a camera provided with a sensor sensitive in near infrared, oriented so as to acquire an image of a face;
a circuit for real-time processing of signals delivered by the camera, in order to determine characteristic points for the image and, by analysing the characteristic points, information relating to at least some indicators comprising:
an inclination of a head in three orthogonal directions;
a position of a pupil;
an opening of an eye;
a configuration of a mouth;
a computer controlled by a program determining the state of vigilance according to the indicators and a change over time thereof;
a first permanent memory configured to perform a plurality of files FDᵢ obtained by a prior processing on a set of images IAᵢ and an indicator qualifying belonging of each of the images to a predetermined class (real face, face that is not a real one);
a second permanent memory configured to record a plurality of files FCᵢ obtained by a prior processing on a set of images of faces Vᵢ associated with annotations;
the processing circuit operably performing a step of location, in the digital image delivered by the camera, of zones corresponding to the face, by applying a detection processing using the files IAᵢ;
the processing operably determining the characteristic points by applying a detection processing using the files Vᵢ; and
the information relating to the state of the head of the operator comprises indicators on the inclination of the head in the three orthogonal directions.

2. A system for monitoring the state of vigilance of the operator according to claim 1, wherein the computer is further controlled by a program for detecting the direction of the gaze and calculating an additional indicator.

3. A system for monitoring the state of vigilance of the operator according to claim 1 wherein the frequency of acquisition and processing is greater than 30 images per second.

4. A system for monitoring the state of vigilance of the operator according to claim 1, further comprising a time-stamped recording of the indicators is carried out and the change over time is calculated according to the recordings, over a time range of at least two seconds.

5. A system for monitoring the state of vigilance of the operator according to claim 1, further comprising an alert controlled remotely by the computer, activating a haptic output.

6. A system for monitoring the state of vigilance of the operator according to claim 1, further comprising an alert controlled by the computer, activating an audible output.

7. A system for monitoring the state of vigilance of the operator according to claim 1, further comprising an alert controlled by the computer, activating a light.

8. A system for monitoring the state of vigilance of the operator according to claim 1, further comprising environment sensors not connected to the operator, delivering an additional signal for computing the state of vigilance.

9. A system for monitoring the state of vigilance of the operator according to claim 1, further comprising at least one physiological sensor connected to the operator, delivering an additional signal for computing the state of vigilance.

10. A system for monitoring the state of vigilance of the operator according to claim 1, further comprising indicators are transmitted to a server, and generic information (not connected to a given operator) is computed on risk zones.

11. A system for monitoring the state of vigilance of the operator according to claim 1, further comprising a third memory for recording data coming from a plurality of items of external equipment and a server, for recording additional information for computing the state of vigilance.

12. A system for monitoring the state of vigilance of the operator according to claim 11, wherein the server is configured so as also to receive external data and to transmit additional information to each item of local equipment.

13. A system for monitoring the state of vigilance of the operator according to claim 1, wherein at least some of the images acquired by the camera are transmitted to a server, in order to supplement the files FCᵢ.

14. A system for monitoring the state of vigilance of the operator according to claim 1, further comprising a source emitting in the near infrared in order to illuminate the face of the operator.

15. A system for monitoring the state of vigilance of the operator according to claim 1, further comprising a remote toll-payment circuit.
